(19) United States
(12) Patent Application Publication
(10) Pub. No.: US 2023/0294968 A1
(43) Pub. Date: Sep. 21, 2023

(54) VEHICLE BODY CONVEYANCE SYSTEM

(71) Applicant: Honda Motor Co., Ltd., Tokyo (JP)

(72) Inventors: Shuhei KONDO, Tokyo (JP); Tomoki MUROZONO, Tokyo (JP)

(73) Assignee: Honda Motor Co., Ltd., Tokyo (JP)

(21) Appl. No.: 18/169,849

(22) Filed: Feb. 15, 2023

(30) Foreign Application Priority Data
Mar. 17, 2022 (JP) 2022-042441

(51) Int. Cl. B66F 9/18; B66F 9/06

(52) U.S. Cl. CPC B66F 9/18; B66F 9/063

(57) ABSTRACT

A vehicle body conveyance system includes: an unmanned carrier conveying a vehicle body between multiple work stations; and a positioning pin standing on a work station. The unmanned carrier is provided with a driving part, a pair of gripping parts, a lifting part, and a control part. The control part is configured to: control the gripping parts, so that a left-right width between the pair of gripping parts fits a left-right width between a pair of side sills of the vehicle body, control the lifting part to lift up the vehicle body to separate the positioning hole of the vehicle body from the positioning pin; control the driving part to move the unmanned carrier to another work station, and control the lifting part to lower the vehicle body to insert the positioning hole through the positioning pin standing on the another work station.

### CROSS-REFERENCE TO RELATED APPLICATION

This application claims the priority benefit of Japan application serial No. 2022-042441, filed on Mar. 17, 2022. The entirety of the above-mentioned patent application is hereby incorporated by reference herein and made a part of this specification.

### BACKGROUND

### Technical Field

The disclosure relates to a vehicle body conveyance system.

### Description of Related Art

In the manufacturing processes of vehicles known as prototype vehicles or production vehicles, a vehicle body conveyance system including an unmanned carrier which conveys a vehicle body between multiple work stations is used. As techniques relating to such vehicle body conveyance system, Patent Document 1, for example, discloses a technique for conveying a vehicle body between an unmanned carrier and a work station.

### PRIOR ART DOCUMENT

### Patent Document

[Patent Document 1] Japanese Laid-open No. 2006-123684

Meanwhile, in a vehicle manufacturing process, etc., a common work station may be used to manufacture not only one vehicle model, but vehicles of multiple vehicle models. Therefore, a vehicle body conveyance system may be easily applicable to manufacturing processes, etc., of vehicles of multiple vehicle models.

### SUMMARY

An aspect of the disclosure provides a vehicle body conveyance system including an unmanned carrier conveying a vehicle body between multiple work stations. The vehicle body conveyance system includes: positioning pins, standing on the work stations to be inserted through positioning holes formed in the vehicle body. The unmanned carrier includes: a driving part, driving the unmanned carrier; a pair of gripping parts, respectively gripping lower surfaces of a pair of side sills provided on left and right of the vehicle body; a lifting part, lifting and lowering the gripping parts; and a control part, respectively controlling the driving part, the gripping parts, and the lifting part. The control part is configured to: control the gripping parts, so that a left-right width between the pair of gripping parts fits a left-right width between the pair of side sills of the vehicle body, control the lifting part to lift up the vehicle body to separate the positioning hole of the vehicle body from the positioning pin, control the driving part to move the unmanned carrier to another one of the work stations, and control the lifting part to lower the vehicle body to insert the positioning hole through the positioning pin standing on the another work station.

### BRIEF DESCRIPTION OF THE DRAWINGS

FIG. 1 is a perspective view illustrating an unmanned carrier of a vehicle body conveyance system according to an embodiment.

FIG. 2 is a perspective view illustrating an internal configuration of the unmanned carrier.

FIG. 3 is a schematic bottom view illustrating an example of a vehicle body conveyed by the unmanned carrier.

FIG. 4 is a cross-sectional view illustrating a self-alignment mechanism when a lower surface of a side sill is gripped by using a gripping part.

FIG. 5 is a side view illustrating a state in which the gripping part is located between a pair of jack-up points.

FIG. 6 is a perspective view illustrating a work station including positioning pins.

FIG. 7 is a view illustrating a state in which the unmanned carrier is positioned with respect to a guide rail of the work station by using a guide roller.

FIG. 8 is a side view illustrating a state in which the vehicle body is mounted on the work station in a vehicle body reload sequence.

FIG. 9 is a side view illustrating a state in which the unmanned carrier arrives at the work station on which the vehicle body is mounted in the vehicle body reload sequence.

FIG. 10 is a side view illustrating a state in which the vehicle body is lifted up by the gripping part in the vehicle body reload sequence.

FIG. 11 is a side view illustrating a state in which the vehicle body is lifted up to be moved out of the work station by the gripping part in the vehicle body reload sequence.

FIG. 12 is a side view illustrating a state in which the vehicle body lifted up by the gripping part is lowered outside the work station in the vehicle body reload sequence.

### DESCRIPTION OF THE EMBODIMENTS

The disclosure provides a vehicle body conveyance system of the disclosure is to be easily applicable to vehicles of multiple vehicle models.

A vehicle body conveyance system (100) according to an aspect of the disclosure includes an unmanned carrier (1) conveying a vehicle body (BD) between multiple work stations (ST). The vehicle body conveyance system (100) includes: positioning pins (SP), standing on the work stations (ST) to be inserted through positioning holes (BH) formed in the vehicle body (BD). The unmanned carrier (1) includes: a driving part (11), driving the unmanned carrier (1); a pair of gripping parts (12), respectively gripping lower surfaces (BSa) of a pair of side sills (BS) provided on left and right of the vehicle body (BD); a lifting part (13), lifting and lowering the gripping parts (12); and a control part (10), respectively controlling the driving part (11), the gripping parts (12), and the lifting part (13). The control part (10) is configured to: control the gripping parts (12), so that a left-right width between the pair of gripping parts (12) fits a left-right width between the pair of side sills (BS) of the vehicle body (BD), control the lifting part (13) to lift up the vehicle body (BD) to separate the positioning hole (BH) of the vehicle body (BD) from the positioning pin (SP); control the driving part (11) to move the unmanned carrier (1) to another work station (ST), and control the lifting part (13) to lower the vehicle body BD to insert the positioning hole BH through the positioning pin SP standing on the another work station ST.

According to the vehicle body conveyance system (100), the positioning pin (SP) inserted through the positioning hole (BH) formed in the vehicle body (BD) stands on each of the work stations (ST). In addition, the unmanned carrier (1) exerts control by using the control part (10) as follows to convey the vehicle body (BD) between the work stations (ST). That is, from the state in which the positioning holes (BH) of the vehicle body (BD) are inserted through by the positioning pins (SP) of the work station (ST), the unmanned carrier (1) fits the left-right width between the pair of gripping parts (12) with the left-right width between the pair of side sills (BS) of the vehicle body (BD), and separates the positioning holes (BH) of the vehicle body (BD) from the positioning pins (SP) by lifting up the vehicle body (BD) using the gripping parts (12). Then, the unmanned carrier (1) moves to another work station (ST), and, by lowering the vehicle body (BD), the positioning holes (BH) are inserted through by the position pins (SP) of the another work station (ST). In this way, since it is possible to adjust the left-right width between the pair of gripping parts (12) to fit the left-right width between the pair of side sills (BS) of the vehicle body (BD), the vehicle body conveyance system (100) is easily applicable to vehicles of multiple vehicle models.

In the vehicle body conveyance system (100) according to an aspect of the disclosure, the gripping part (12) has a front-rear length equal to a front-rear width between the pair of jack-up points (BJ) provided at the front and the rear of the side sill (BS), and in a case of conveying the vehicle body (BD), when the vehicle body (BD) moves forward or rearward with respect to the gripping part (12), the gripping part (12) contacts the jack-up point (BJ). Accordingly, even in the case where the vehicle body (BD) moves forward or backward during conveyance of the vehicle body (BD), the movement amount of the vehicle body (BD) is limited through the contact of the jack-up points (BJ) with the gripping parts (12). Therefore, the movement of the vehicle body (BD) can be suppressed.

It should be noted that the reference numerals in parentheses above indicate the reference numerals of the components in the embodiments described afterwards as examples of the disclosure, and shall not be construed to limit the disclosure to the aspects of the embodiments.

In this way, the vehicle body conveyance system of the disclosure is easily applicable to vehicles of multiple vehicle models.

Exemplary embodiments are described below with reference to the drawings. In addition, the same reference numerals are given to the same or corresponding parts in the respective figures, and repetitive descriptions are omitted.

### Vehicle Body Conveyance System

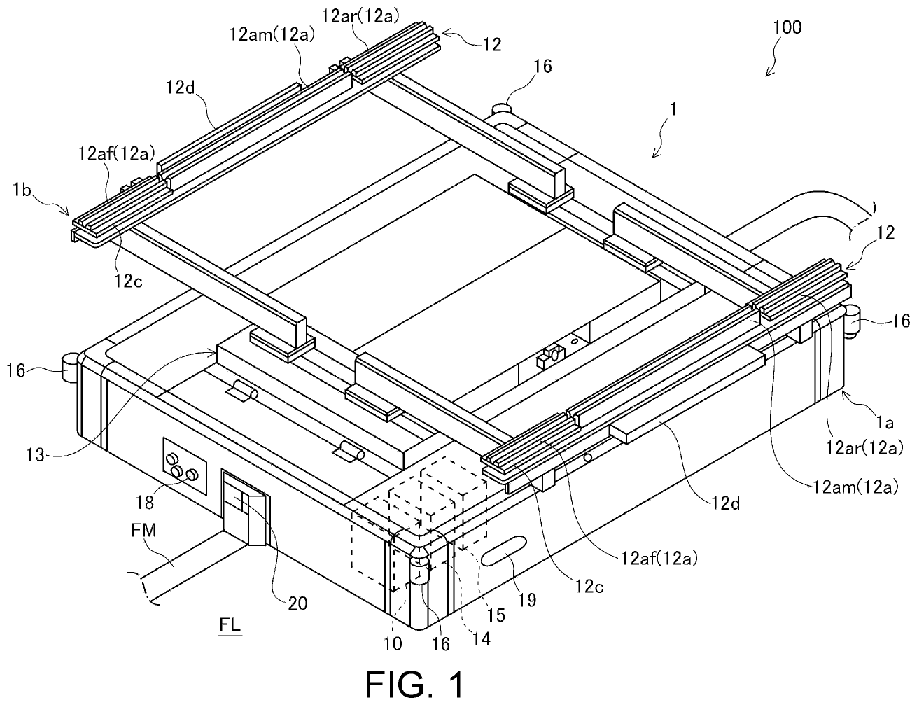

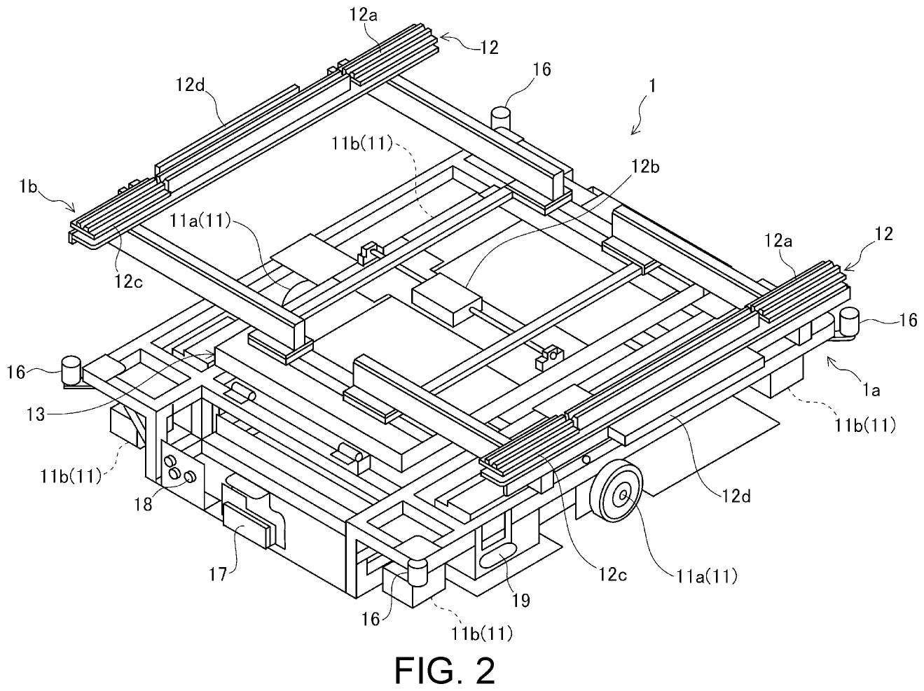

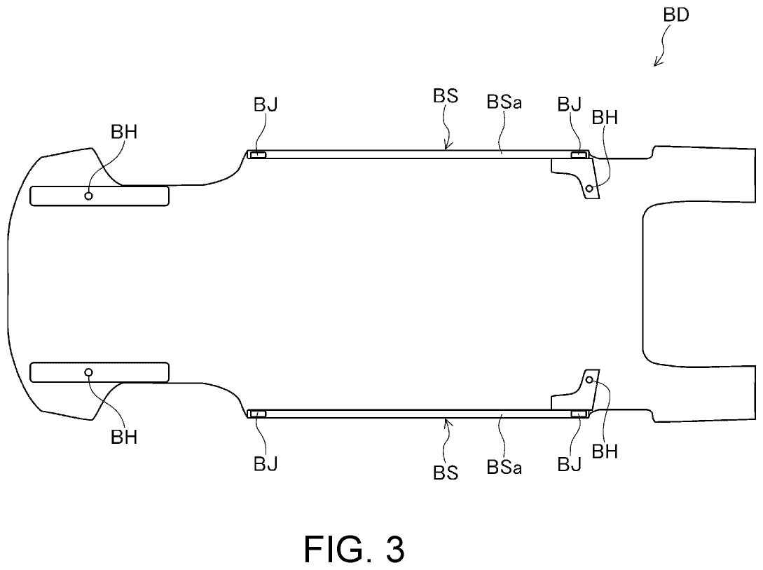

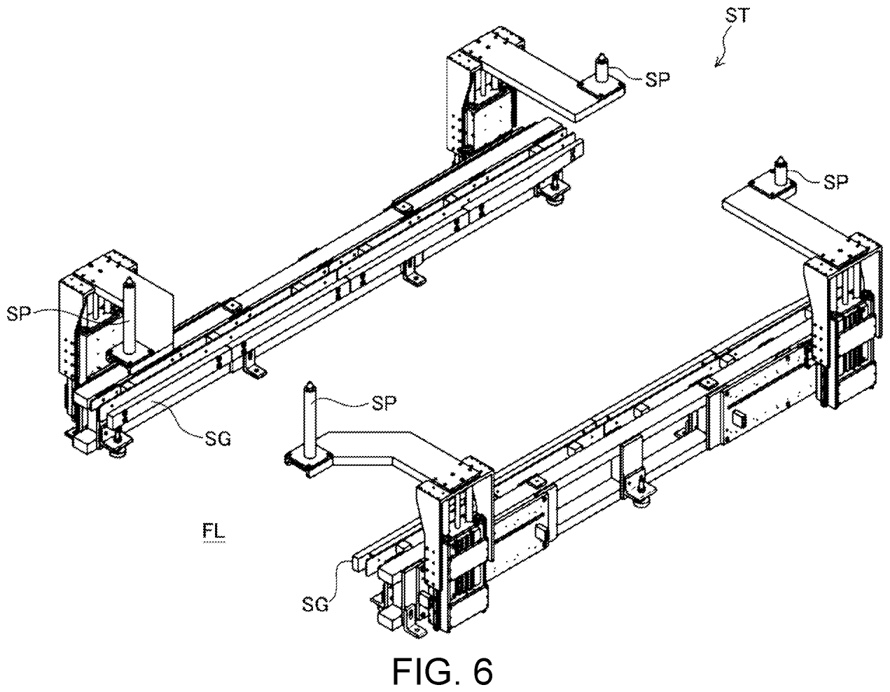

FIG. 1 is a perspective view illustrating an unmanned carrier 1 of a vehicle body conveyance system 100 according to an embodiment. FIG. 2 is a perspective view illustrating an internal configuration of the unmanned carrier 1. FIG. 3 is a schematic bottom view illustrating an example of a vehicle body BD conveyed by the unmanned carrier 1. As shown in FIGS. 1 to 3, the vehicle body conveyance system 100 is a conveyance system including the unmanned carrier 1 that conveys the vehicle body BD and positioning pins SP (see FIG. 6) standing on a work station ST.

The vehicle body conveyance system 100 is configured to, for example, in a vehicle manufacturing process, convey the vehicle body BD between multiple work stations ST, and mount the vehicle body BD in a suitably positioned state in each work station ST. That is, according to the vehicle body conveyance system 100, the conveyance of the vehicle body BD and the transfer of the vehicle body BD between the unmanned carrier 1 and the work station ST can be automatized. The respective manufacturing processes of the vehicle may include processes such as bonding, coating, and assembling, etc. The vehicle body conveyance system 100 is not limited to a single vehicle model, but may also be applicable to the vehicle manufacturing processes of multiple vehicle models.

“Vehicle body” refers to a component forming at least a portion of a vehicle in a vehicle manufacturing process, and may be a frame portion of a vehicle formed by a monocoque. The vehicle body BD is provided with a pair of side sill BS on the left and the right. Each side sill BS is a component linearly extending between the wheel arch of the front wheel and the wheel arch of the rear wheel at the left or right end of the vehicle body BD.

A pair of jack-up points BJ are provided at the front and the rear of each of the left and right side seals BS. “Jack-up point” refers to a position intended to be a contact point with a jack when a vehicle is to be jacked up. Here, the jack-up point BJ is configured as a protrusion part protruding downward from a lower surface BSa of the side sill BS.

In addition, on the bottom surface of the vehicle body BD, multiple positioning holes BH for insertion of the positioning pins SP standing on the work station ST are formed. Specifically, four positioning holes BH are provided at the front and rear ends on the left and right of the bottom surface of the vehicle body BD. That is, the four position holes BH are provided at the four corners of the vehicle body BD.

### Unmanned Carrier

The unmanned carrier 1 is a carrier able to convey an object, such as the vehicle body BD, between the work stations ST. The unmanned carrier 1 is able to operate automatically without an operator. For example, the unmanned carrier 1 may be an automatic guided vehicle (AGV). That is, the unmanned carrier 1 is configured to be movable along a magnetic tape FM while detecting the magnetic tape FM that is provided on a floor FL of a factory, etc., in which the unmanned carrier 1 is operated by using a magnetic sensor 17. The unmanned carrier 1 is not necessarily limited to a truck moving along the magnetic tape FM, but may also be a truck that moves while referring to a three-dimensional map generated through simultaneous localization and mapping (SLAM).

The unmanned carrier 1 includes a body part 1a in a flat rectangular parallelepiped shape and an object gripping part 1b that grips an object and is provided on the upper surface side of the body part 1a. Here, the object gripped by the object gripping part 1b is the vehicle body BD.

The body part 1a of the unmanned carrier 1 includes a control part 10 and a driving part 11. In addition, the body part 1a may include a communication part 14, a battery 15, a guide roller 16, the magnetic sensor 17, a start switch 18, a blinker 19, and an obstacle sensor 20. The object gripping part 1b of the unmanned carrier 1 includes gripping parts 12 and a lifting part 13.

The control part 10 is a controller that controls the operations of the respective parts of the unmanned carrier 1, including the driving part 11, the gripping parts 12, and the lifting part 13. The control part 10 may further control the communication part 14, the battery 15, and the blinker 19.

The driving part 11 is a part that drives the unmanned carrier 1. The driving part 11 has a pair of driving wheels 11a provided at the central parts at the left and right ends of the body part 1a in the front-rear direction. The power source of the pair of driving wheels 11a may be, for example, the battery 15. The driving part 11 has four driven wheels 11b respectively provided at the front and rear ends of the left and right ends of the body part 1a. That is, the driven wheels 11b are respectively provided at the four corners of the body part 1a.

The gripping part 12 grips the lower surface BSa of each of the pair of side sills BS provided on the left and the right of the vehicle body BD. That is, a pair (two) of the gripping parts 12 are provided in correspondence with the pair of side sills BS. The gripping part 12 has a gripping rail 12a, a gripping part left-right width adjustment mechanism 12b, a gripping part front-rear length adjustment mechanism 12c, and a touch sensor 12d.

The gripping rail 12a is an elongated member extending in the vehicle front-rear direction. A V-shaped concave part 12aa facing from the upper surface toward the lower surface side is formed on the gripping rail 12a. The concave part 12aa has a horizontal bottom surface 12ab, and is formed from the front end over the rear end of the gripping part 12. The concave part 12aa is a portion which grips the lower surface BSa of the side sill BS of the vehicle body BD when the unmanned carrier 1 conveys the vehicle body BD. “Gripping” refers to supporting or fixing an object, and is not necessarily limited to sandwiching an object from two sides.

The gripping rail 12a has a front-rear length equal to a front-rear width between the pair of jack-up points BJ in each side sill BS of the vehicle body BD that is conveyed. Here, “equal to” includes “substantially equal to”. That is, the front-rear width of the gripping rail 12a may be completely the same as or slightly differ in length from the front-rear width between the pair of jack-up points BJ. The front-rear width of the gripping rail 12a may be slightly shorter than the front-rear width between the pair of jack-up points BJ. Accordingly, the required positioning accuracy when the lower surface BSa of the side sill BS is gripped by the gripping rail 12a is relaxed. However, if the front-rear width of the gripping rail 12a is excessively shorter than the front-rear width between the pair of jack-up points BJ, it is difficult to secure the positioning accuracy required for inserting the positioning pins SP of the work station ST through the positioning holes BH of the vehicle body BD described subsequently.

The gripping part left-right width adjustment mechanism 12b is a mechanism for adjusting the left-right width between the pair of gripping parts 12 (specifically, the pair of gripping rails 12a). The gripping part left-right width adjustment mechanism 12b translates each of the pair of gripping rails 12a in the left-right direction. For example, the gripping part left-right width adjustment mechanism 12b may also be an actuator connected with each of the pair of gripping rails 12a. In such case, the gripping part left-right width adjustment mechanism 12b may operate with power supplied from the battery 15.

The gripping part front-rear length adjustment mechanism 12c is a mechanism for adjusting the front-rear length of each gripping part 12 (specifically, each gripping rail 12a). Here, each gripping rail 12a is divided into three members (a front member 12af, a central member 12am, and a rear member 12ar) in the front-rear direction. The gripping part front-rear length adjustment mechanism 12c moves the front member 12af and the rear member 12ar forward and rearward in the front-rear direction. For example, the gripping part front-rear length adjustment mechanism 12c may also be an actuator connected to each gripping rail 12a. In such case, the gripping part front-rear length adjustment mechanism 12c may operate with power supplied from the battery 15. Alternatively, the gripping part front-rear length adjustment mechanism 12c may also be a mechanism operated manually.

The touch sensor 12d is a switch for emergency stop provided on the outer side surface of each gripping rail 12a. The touch sensor 12d stops the operation of the unmanned carrier 1 by being pressed.

The lifting part 13 is a part that lifts and lowers the gripping part 12. The lifting part 13, for each gripping part 12, lifts the vehicle body BD in a state in which the lower surface BSa of the side sill BS is gripped by the griping part 12. “Lifting” covers the notions of raising and lowering. For example, the lifting part 13 may be an actuator contractible in the upper-lower direction and interposed between the body part 1a and the gripping part 12. In such case, the lifting part 13 may operate with power supplied from the battery 15.

The communication part 14 is a part that performs communication with an external machine. The communication part 14 may carry out communication in an arbitrary manner. For example, the communication part 14 may receive a control signal of the unmanned carrier 1 from an image capturing device provided on a ceiling side of the factory, etc., in which the unmanned carrier 1 is operated. Alternatively, the communication part 14 may also receive the control signal of the unmanned carrier 1 from a separately provided device.

The battery 15 supplies power for operating each part of the unmanned carrier 1. Multiple batteries 15 may be mounted. For example, the battery 15 may be removed from the unmanned carrier 1 to be charged, and may also be charged while being mounted on the unmanned carrier 1.

The guide roller 16 is a part that guides the unmanned carrier 1 to turn along a wall, etc., in the case where the unmanned carrier 1 is interfered with an obstacle such as a wall. The guide roller 16 is a cylindrical rotation body rotatably provided around a central axis extending in the upper-lower direction. The guide roller 16 is each provided at the front and rear ends of the left and right ends of the body part 1a (i.e., the four corners of the body part 1a). That is, here, four guide rollers 16 are provided. As described in the following, when the unmanned carrier 1 arrives at the work station ST, the guide roller 16 guides the unmanned carrier 1 to turn smoothly along a guide rail SG of the work station ST while rotating along the guide rail SG.

The magnetic sensor 17 and the obstacle sensor 20 are sensors that detect external conditions of the unmanned carrier 1. The magnetic sensor 17 may also be a magnetic detector that detects the magnetic tape FM provided on the floor FL of the factory, etc., in which the unmanned carrier 1 is operated, for example. In addition, the obstacle sensor 20 may include a distance sensor, for example, and detect whether an obstacle is present in the traveling direction of the unmanned carrier 1. In the case where the unmanned carrier 1 is a truck that moves while referring to a three-dimensional map generated by SLAM, for example, a camera (not shown) that photographs the periphery of the unmanned carrier 1 may also be provided as an external sensor.

The start switch 18 is an input switch for starting or stopping the unmanned carrier 1. The start switch 18 may have an arbitrary shape. In addition, the start switch 18 may be remotely operable through wireless communication.

The blinker 19 is a direction indicator that indicates the direction in which the unmanned carrier 1 is about to travel. Although the specific configuration of the blinker 19 is not limited, for example, the blinker 19 may be configured to make the light in the direction in which the unmanned carrier 1 turns blink.

### Positioning Mechanism

A positioning mechanism when the pair of gripping parts 12 respectively grip the lower surfaces

BSa of the side sills BS of the vehicle body BD is described.

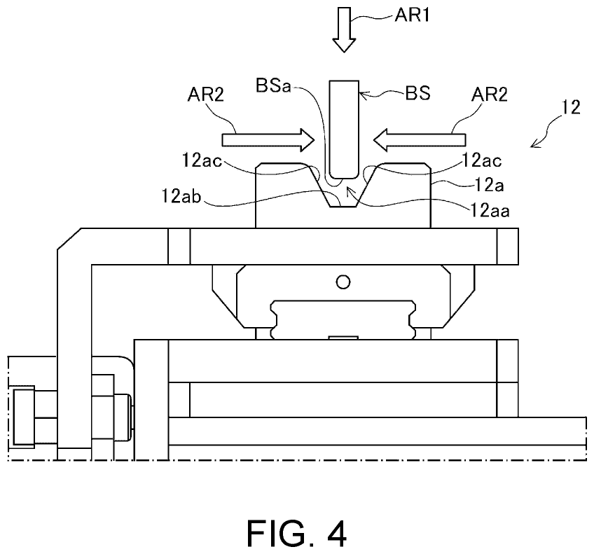

Firstly, a self-alignment mechanism that positions the vehicle body BD with respect to the gripping parts 12 in the left-right direction is described. FIG. 4 is a cross-sectional view illustrating a self-alignment mechanism when the lower surface BSa of the side sill BS is gripped by using the gripping part 12. As shown in FIG. 4, when viewed in the front-rear direction, the V-shaped concave part 12aa facing from the upper surface toward the lower surface side is formed on the gripping rail 12a of the gripping part 12. That is, the concave part 12aa is open on the upper surface of the gripping rail 12a, and the diameter of the concave part 12aa is reduced downward in the left-right direction. Therefore, in the case where the side sill BS of the vehicle body BD is to be mounted into the concave part 12aa of the gripping rail 12a from the top (as indicated by an arrow AR1 of FIG. 4), when being at a position deviated to a certain extent in the left-right direction, the side sill BS is guided to the central side of the concave part 12aa by an inclined surface 12ac forming the concave part 12aa (as indicated by an arrow AR2 in FIG. 4). Therefore, the vehicle body BD is positioned in the left-right direction with respect to the gripping part 12.

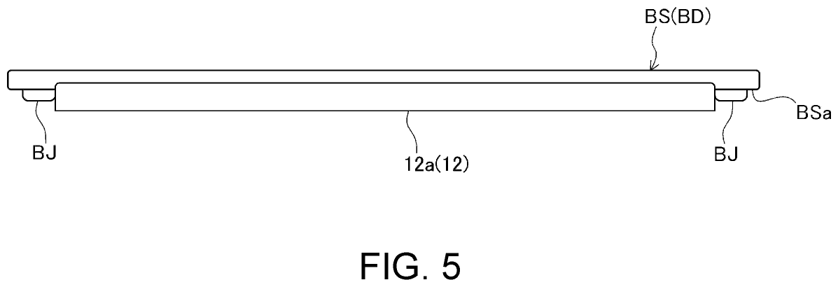

Therefore, the mechanism for positioning the vehicle body BD in the front-rear direction with respect to the gripping part 12 is described. FIG. 5 is a side view illustrating a state in which the gripping part 12 is located between the pair of jack-up points BJ. As shown in FIG. 5, the front-rear length of the gripping rail 12a is equal to the front-rear width between the pair of jack-up points BJ provided in each side sill BS. Therefore, in the case where the lower surface BSa of the side sill BS is gripped by the gripping part 12, the gripping part 12 (more specifically, the gripping rail 12a) is located between the pair of jack-up points BJ. Therefore, when the vehicle body BD moves forward or rearward with respect to the gripping part 12 in the case of conveying the vehicle body BD, the gripping part 12 contacts the jack-up points BJ. Specifically, when the vehicle body BD moves forward with respect to the gripping part 12, the rear end surface of the gripping rail 12a contacts the jack-up point BJ on the rear side of the vehicle body BD, and the forward movement of the vehicle body BD is limited. Comparatively, when the vehicle body BD moves rearward with respect to the gripping part 12, the front end surface of the gripping rail 12a contacts the jack-up point BJ on the front side of the vehicle body BD, and the rearward movement of the vehicle body BD is limited. In addition, since the gripping part 12 is a configuration gripping portions other than the jack-up points BJ, the vehicle body BD is easily reloaded even with respect to the work station ST using a two-post lift, etc., supporting the vehicle body BD at the jack-up points BJ.

### Work Station

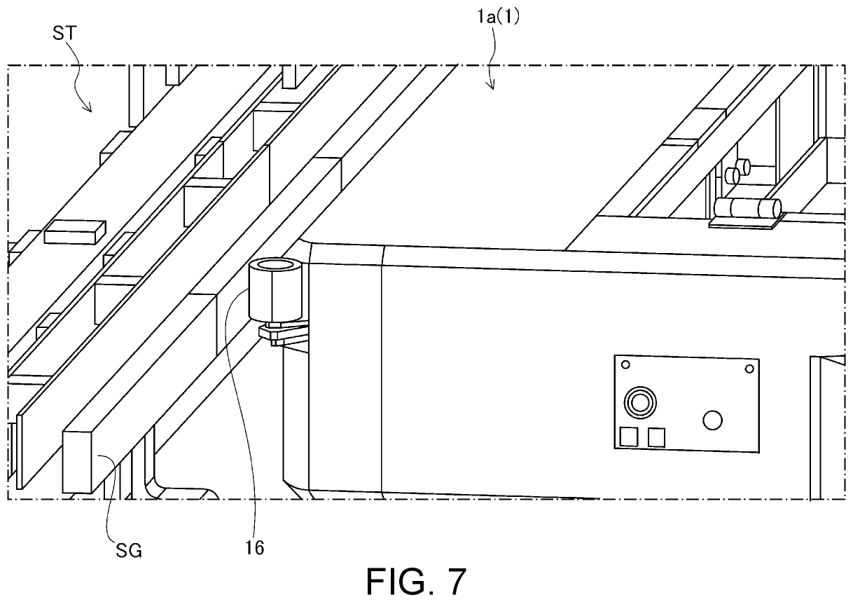

The configuration of the work station ST is described. The work station ST is a place for performing an operation, etc., with respect to the vehicle body BD, for example. In the work station ST, the vehicle body BD is lowered from the unmanned carrier 1 to be mounted on the work station ST. FIG. 6 is a perspective view illustrating the work station ST including the positioning pins SP. FIG. 7 is a view illustrating a state in which the unmanned carrier 1 is positioned with respect to the guide rail SG of the work station ST by using the guide roller 16. As shown in FIGS. 6 and 7, the work station ST is provided with a pair of guide rails SG and the positioning pins SP.

The pair of guide rails SG are provided to face each other, so as to be substantially parallel to each other. The separation distance between the pair of guide rails SG is substantially equal to the left-right width of the body part 1a of the unmanned carrier 1. More specifically, the separation distance between the pair of guide rails SG is substantially equal to the width between the left end of the guide roller 16 provided on the left side of the body part 1a and the right end of the guide roller 16 provided on the right side of the body part 1a. In addition, the height of each guide rail SG from the floor FL conforms to the height of the guide roller 16 provided at the body part 1a from the floor FL. Accordingly, in the unmanned carrier 1 arriving at the work station ST, the guide roller 16 is guided to turn smoothly along the guide rail SG while rotating along the guide rail SG. An entrance part of the AGV in the guide rail SG is arranged in a tapered shape to tolerate the entrance offset of the unmanned carrier 1.

Each positioning pin SP is a member exhibiting an elongated, substantially cylindrical shape, and stands on the work station ST. Each positioning pin SP is inserted through the positioning hole BH formed in the vehicle body BD. Therefore, each positioning pin SP is provided at a position corresponding to the positioning hole BH of the vehicle body BD. In correspondence with the formation of the four positioning holes BH in the vehicle body BD, the work station ST is provided with four positioning pins SP. By inserting the positioning pins SP through the positioning holes BH, the vehicle body BD is accurately positioned with respect to the work station ST. The work station ST possesses vehicle information relating to the vehicle (the vehicle body BD) being conveyed, and by making the positioning pins SP or a welding jig, etc., variable to fit the shape of the vehicle body BD being conveyed, the work station ST is easily applicable to vehicles of multiple vehicle models.

### Vehicle Body Reload Sequence

The order for reloading the vehicle body BD (reload sequence of the vehicle body BD) between the unmanned carrier 1 and the work station ST is described.

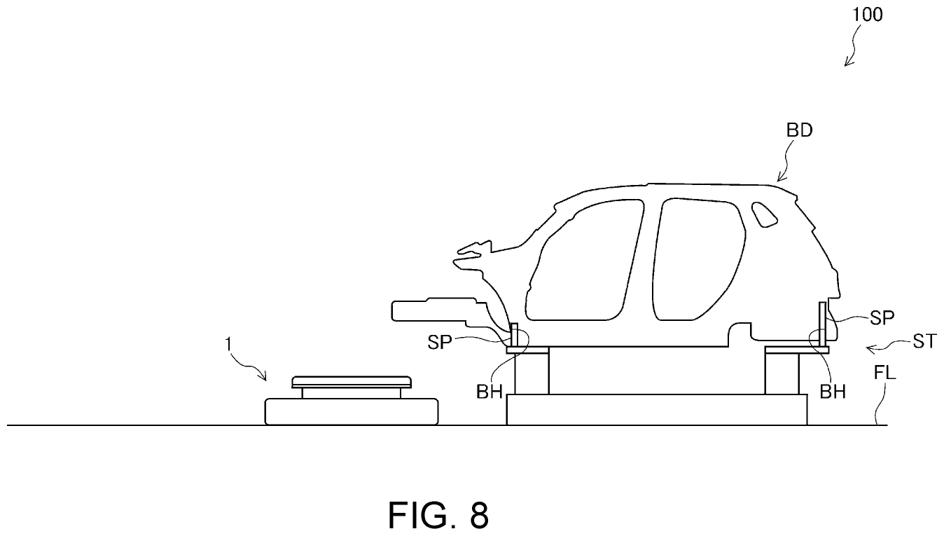

FIG. 8 is a side view illustrating a state in which the vehicle body BD is mounted on the work station ST in the reload sequence of the vehicle body BD. In FIG. 8, the vehicle body BD is mounted on the work station ST in a state in which the positioning holes BH are inserted through by the positioning pins SP standing on the work station ST.

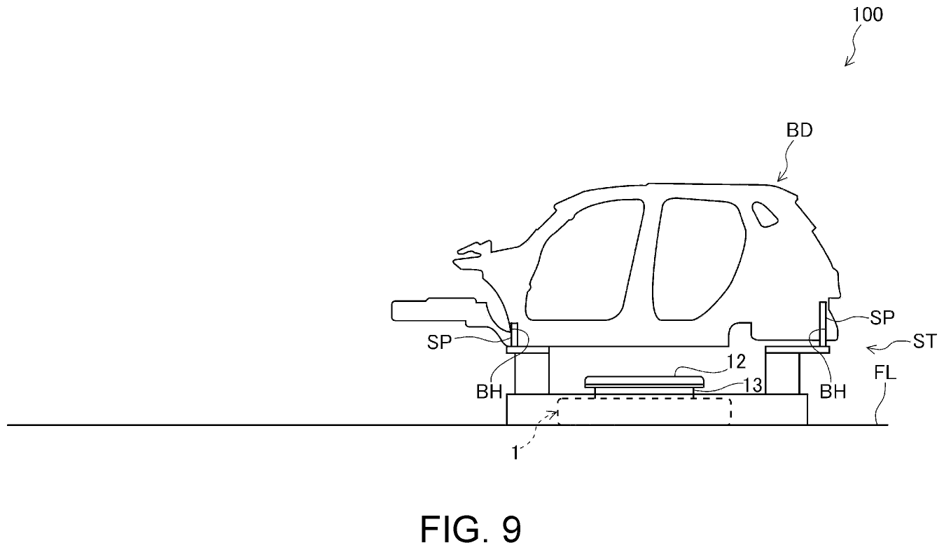

FIG. 9 is a side view illustrating a state in which the unmanned carrier 1 arrives at the work station ST in which the vehicle body BD is mounted on the reload sequence of the vehicle body BD. In FIG. 9, the control part 10 controls the driving part 11 to move the unmanned carrier 1 to the work station ST on which the vehicle body BD is mounted. Accordingly, the unmanned carrier 1 arrives at the work station ST on which the vehicle body BD is mounted. At this time, the unmanned carrier 1 is positioned in the left-right direction with respect to the guide rails SG of the work station ST by using the guide rollers 16 (FIG. 7). In addition, the unmanned carrier 1 may also be positioned in the front-rear direction with respect to the work station ST by using the magnetic tape FM that is provided.

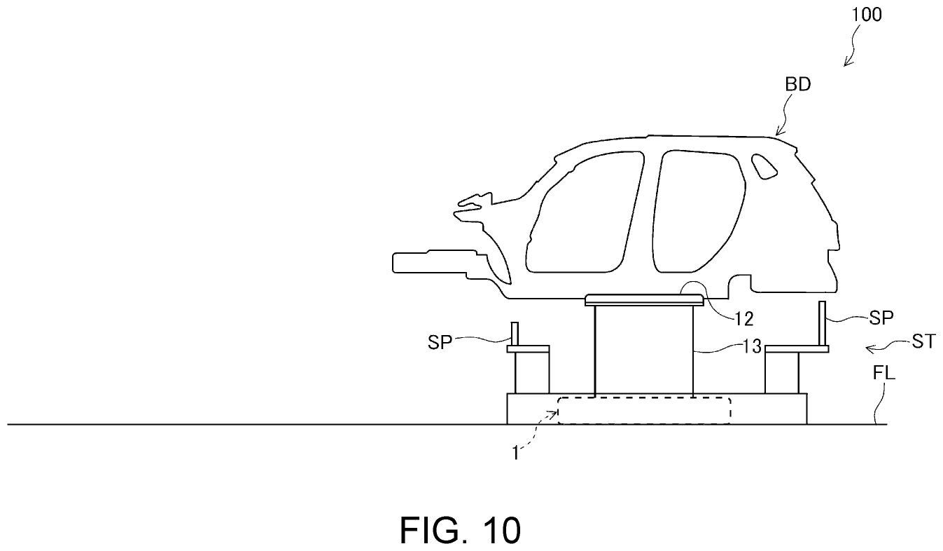

FIG. 10 is a side view illustrating a state in which the vehicle body BD is lifted up by the gripping parts 12 in the reload sequence of the vehicle body BD. In FIG. 10, the control part 10 controls the gripping parts 12, so that the left-right width between the pair of gripping parts 12 fits the left-right width between the pair of side sills BS of the vehicle body BD. Specifically, the control part 10 adjusts the left-right width between the pair of gripping rails 12a by controlling the gripping part left-right width adjustment mechanism 12b. Then, the control part 10 raises the lifting part 13 to grip the lower surfaces BSa of the pair of side sills BS provided at the left and the right of the vehicle body BD by using the gripping parts 12. In addition, the control part 10 controls the lifting part 13 to lift up the vehicle body BD to separate the positioning holes BH of the vehicle body BD from the positioning pins SP.

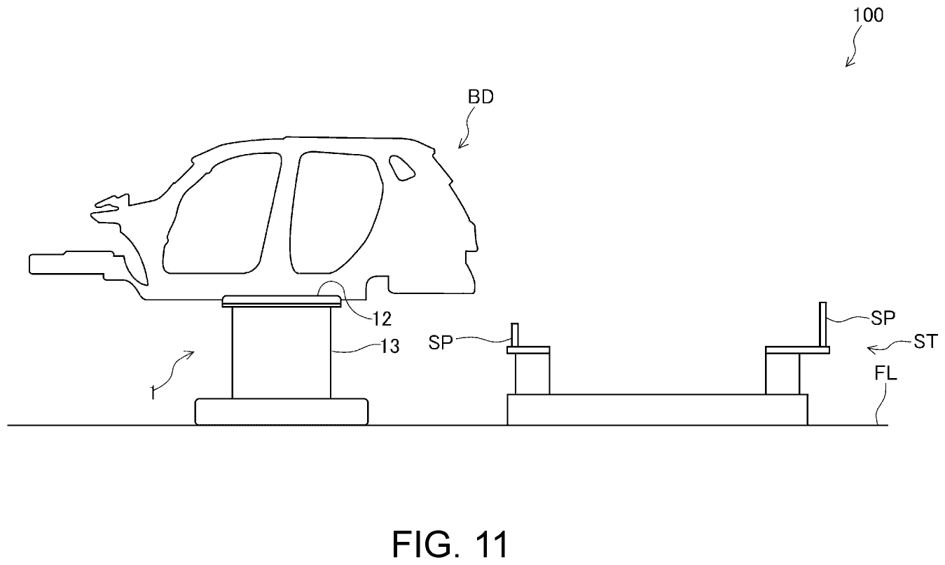

FIG. 11 is a side view illustrating a state in which the vehicle body BD is lifted up to be moved out of the work station ST by the gripping parts 12 in the reload sequence of the vehicle body BD. In FIG. 11, the control part 10 controls the driving part 11 to move the unmanned carrier 1 to another work station ST. In the case where the unmanned carrier 1 arrives at the another work station ST, as shown in FIG. 10, positioning is performed, so that the positioning pins SP are aligned with the positioning holes BH. In addition, as shown in FIG. 9, the control part 10 controls the lifting part 13 to lower the vehicle body BD to insert the positioning holes BH through the positioning pins SP standing on the another work station ST . Accordingly, the vehicle body BD is loaded on the another work station ST.

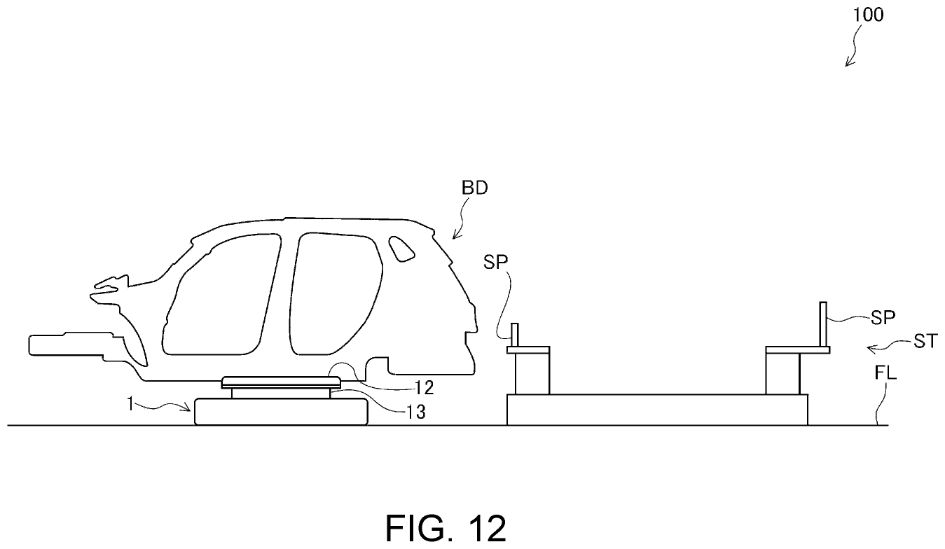

FIG. 12 is a side view illustrating a state in which the vehicle body BD lifted up by the gripping parts 12 is lowered outside the work station ST in the reload sequence of the vehicle body BD. In FIG. 12, the control part 10 controls the lifting part 13 to lower the vehicle body BD at a place other than the work station ST. Accordingly, for example, the stability of movement by the driving part 11 in the state in which the vehicle body BD is gripped by the gripping parts 12 is facilitated.

### Functions and Effects

According to the above, a vehicle body conveyance system 100 includes an unmanned carrier 1 conveying a vehicle body BD between multiple work stations ST. The vehicle body conveyance system 100 includes: positioning pins SP, standing on the work stations ST to be inserted through positioning holes BH formed in the vehicle body BD. The unmanned carrier 1 includes: a driving part 11, driving the unmanned carrier 1; a pair of gripping parts 12, respectively gripping lower surfaces BSa of a pair of side sills BS provided on left and right of the vehicle body BD; a lifting part 13, lifting and lowering the gripping parts 12; and a control part 10, respectively controlling the driving part 11, the gripping parts 12, and the lifting part 13. The control part 10 is configured to: control the gripping parts 12, so that a left-right width between the pair of gripping parts 12 fits a left-right width between the pair of side sills BS of the vehicle body BD, control the lifting part 13 to lift up the vehicle body BD to separate the positioning hole BH of the vehicle body BD from the positioning pin SP; control the driving part 11 to move the unmanned carrier 1 to another work station ST, and control the lifting part 13 to lower the vehicle body BD to insert the positioning hole BH through the positioning pin SP standing on the another work station ST.

According to the vehicle body conveyance system 100, the positioning pin SP inserted through the positioning hole BH formed in the vehicle body BD stands on each of the work stations ST. In addition, the unmanned carrier 1 exerts control by using the control part 10 as follows to convey the vehicle body BD between the work stations ST. That is, from the state in which the positioning holes BH of the vehicle body BD are inserted through by the positioning pins SP of the work station ST, the unmanned carrier 1 fits the left-right width between the pair of gripping parts 12 with the left-right width between the pair of side sills BS of the vehicle body BD, and separates the positioning holes BH of the vehicle body BD from the positioning pins SP by lifting up the vehicle body BD using the gripping parts 12. Then, the unmanned carrier 1 moves to another work station ST, and, by lowering the vehicle body BD, the positioning holes BH are inserted through by the positioning pins SP of the another work station ST. In this way, since it is possible to adjust the left-right width between the pair of gripping parts 12 to fit the left-right width between the pair of side sills BS of the vehicle body BD, the vehicle body conveyance system 100 is easily applicable to vehicles of multiple vehicle models.

In the vehicle body conveyance system 100, the gripping part 12 has a front-rear length equal to a front-rear width between the pair of jack-up points BJ provided at the front and the rear of the side sill BS, and in a case of conveying the vehicle body BD, when the vehicle body BD moves forward or rearward with respect to the gripping part 12, the gripping part 12 contacts the jack-up point BJ. Accordingly, even in the case where the vehicle body BD moves forward or backward during conveyance of the vehicle body BD, the movement amount of the vehicle body BD is limited through the contact of the jack-up points BJ with the gripping parts 12. Therefore, the movement of the vehicle body BD can be suppressed.

### Modified Examples

The embodiments can be implemented in various forms modified or improved based on the knowledge of those skilled in the art.

For example, the shape, etc., of the unmanned carrier 1 may be different from what is shown in the embodiments. Similarly, the shape, etc., of the work station ST may be different from what is shown in the embodiments.

In addition, in the embodiments, four positioning holes BH and four positioning pins SP are provided respectively. However, the numbers of the positioning holes BH and the positioning pins may be other than four. In addition, in each of the work stations ST, the positioning pins SP may also be inserted into different positioning holes BH in the vehicle body BD.

Moreover, in the above embodiments, the jack-up points BJ are configured as protrusion parts protruding downward from the lower surfaces BSa of the side sills BS. However, the jack-up points BJ are not necessarily configured as protrusion parts protruding downward from the lower surfaces BSa of the side sills BS, but, for example, may also be configured as protrusion parts protruding laterally from side surfaces of the side sills BS.

In addition, in each work station ST, the position pins SP may also be fixed so as not to move with respect to the floor FL. Alternatively, the positioning pins SP may also be fixed to be relatively movable with respect to the floor FL. In such case, the work station ST may also include a lift (a two-post lift, a four-post lift, etc.) able to move the positioning pins SP in the upper-lower direction.

What is claimed is:

1. A vehicle body conveyance system, comprising an unmanned carrier conveying a vehicle body between a plurality of work stations, the vehicle body conveyance system comprising:
positioning pins, standing on the work stations to be inserted through positioning holes formed in the vehicle body,
wherein the unmanned carrier comprises:
a driving part, driving the unmanned carrier;
a pair of gripping parts, respectively gripping lower surfaces of a pair of side sills provided on left and right of the vehicle body;
a lifting part, lifting and lowering the gripping parts; and
a control part, respectively controlling the driving part, the gripping parts, and the lifting part,
wherein the control part is configured to:
control the gripping parts, so that a left-right width between the pair of gripping parts fits a left-right width between the pair of side sills of the vehicle body,
control the lifting part to lift up the vehicle body to separate the positioning hole of the vehicle body from the positioning pin,
control the driving part to move the unmanned carrier to another one of the work stations, and
control the lifting part to lower the vehicle body to insert the positioning hole through the positioning pin standing on the another work station.

2. The vehicle body conveyance system as claimed in claim 1,
wherein the gripping part has a front-rear length equal to a front-rear width between a pair of jack-up points provided at front and rear of the side sill, and
in a case of conveying the vehicle body, when the vehicle body moves forward or rearward with respect to the gripping part, the gripping part contacts the jack-up point.
